(19) United States
(12) Patent Application Publication
(10) Pub. No.: US 2023/0418590 A1
(43) Pub. Date: Dec. 28, 2023

(54) INSTRUCTION UPDATES

(71) Applicant: Hewlett-Packard Development Company, L.P., Spring, TX (US)

(72) Inventors: Mason Andrew Gunyuzlu, Spring, TX (US); Rosilet Retnamoni Braduke, Cypress, TX (US); Jeffrey Kevin Jeansonne, Houston, TX (US); James Luke Mondshine, Houston, TX (US)

(21) Appl. No.: 17/846,752

(22) Filed: Jun. 22, 2022

(51) Int. Cl. G06F 8/654; G06F 21/57; H04L 9/32

(52) U.S. Cl. CPC G06F 8/654; G06F 21/572; H04L 9/3239; G06F 2221/033

(57) ABSTRACT

Examples of electronic devices are described herein. In some examples, an electronic device includes a flash memory. In some examples, the electronic device includes a basic input/output system (BIOS). In some examples, the electronic device includes a controller to unlock a region of the flash memory based on a message from the BIOS. In some examples, the electronic device includes an operating system (OS). In some examples, an application in the OS updates instructions in the region when the OS is loaded and the electronic device is in an awake state. In some examples, the controller locks the region after the update.

### BACKGROUND

Computing devices execute programs to perform functions. For instance, a computing device may include a program in memory that may be executed by a processor. Examples of computing devices include desktop computers, laptop computers, tablet devices, and smartphones.

### BRIEF DESCRIPTION OF THE DRAWINGS

FIG. 1 is a thread diagram illustrating an example of an instruction update in accordance with some examples of the techniques described herein;

FIG. 2 is a block diagram illustrating an example of an electronic device that may be used to perform an instruction update;

FIG. 3 is a block diagram illustrating an example of a computing device to perform an instruction update;

FIG. 4 is a block diagram illustrating an example of a computer-readable medium for an instruction update;

FIG. 5 is a flow diagram illustrating an example of a method for updating instructions;

FIG. 6 is a flow diagram illustrating an example of a method for checking instructions; and

FIG. 7 is a flow diagram illustrating an example of a method for managing update checking.

### DETAILED DESCRIPTION

In some approaches, firmware updates occur in a pre-boot environment where trusted code may be executed. This may help ensure the security and resilience of the firmware. However, updating firmware in a pre-boot environment may cause a period where some device functions are unavailable, leading some users to avoid updating firmware.

Because firmware may have a significant impact on device functionality, it may be helpful to reduce the difficulty and inconvenience of updating firmware. Some examples of the techniques described herein may reduce time in a pre-boot environment to update firmware, to increase update security, or a combination thereof. For instance, some procedures may be performed while a device is in an awake state (e.g., performed as a background task in an operating system (OS)). Some examples of the techniques may enable updating firmware in an untrusted environment (e.g., OS environment) while enhancing security.

Throughout the drawings, similar reference numbers may designate similar or identical elements. When an element is referred to without a reference number, this may refer to the element generally, without limitation to any particular drawing or figure. In some examples, the drawings are not to scale, and the size of some parts may be exaggerated to more clearly illustrate the example shown. Moreover, the drawings provide examples in accordance with the description. The description is not limited to the examples provided in the drawings.

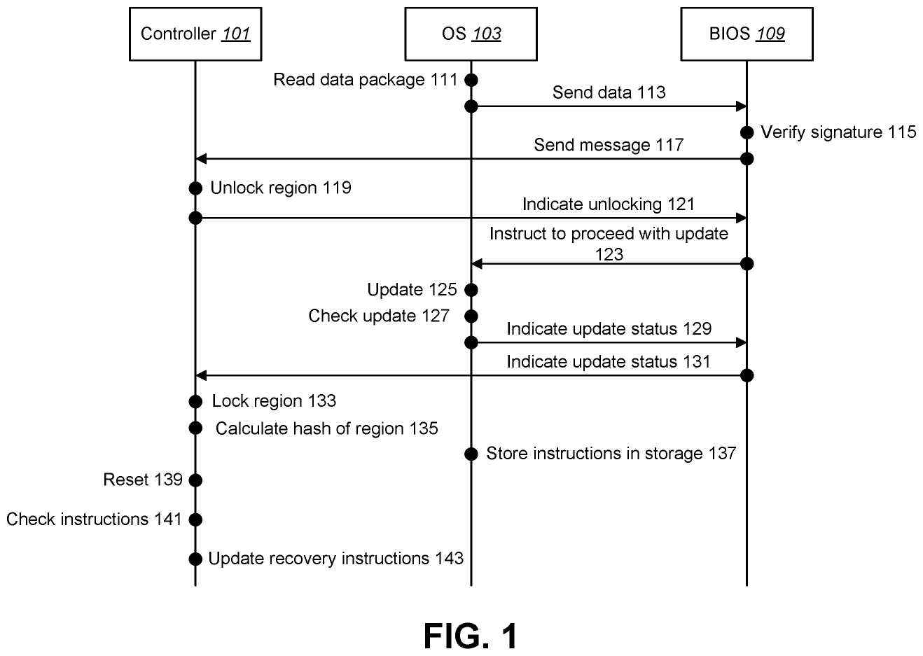

FIG. 1 is a thread diagram illustrating an example of an instruction update in accordance with some examples of the techniques described herein. FIG. 1 illustrates examples of a controller 101, an OS 103, and a basic input/output system (BIOS) 109. In some examples, the controller 101, OS 103, and BIOS 109 may be components of an apparatus, electronic device (e.g., electronic device 202), or computing device (e.g., computing device 338).

An electronic device is a device that includes electronic circuitry (e.g., integrated circuitry). A computing device is an electronic device that includes a processor, logic circuitry, or a combination thereof. Examples of computing devices may include desktop computers, laptop computers, tablet devices, smartphones, televisions, game consoles, smart speakers, voice assistants, Internet of Things (IoT) devices, etc. A computing device may utilize processor(s) or logic circuitry to perform an operation or operations. In some examples, computing devices may execute instructions stored in memory to perform the operation(s). Instructions may be code or programming that specifies functionality or an operation of a processor or logic circuitry.

In some examples, data (e.g., information, instructions, or a combination thereof) may be stored in memory (e.g., volatile memory, non-volatile memory, or a combination thereof). Examples of memory may include Random Access Memory (RAM), Read-Only Memory (ROM), Erasable Programmable ROM (EPROM), Electrically Erasable Programmable ROM (EEPROM), flash memory, etc.), a storage device, an optical disc, the like, or a combination thereof. For instance, data may be stored in volatile or non-volatile memory, such as Dynamic Random Access Memory (DRAM), embedded MultiMediaCard (eMMC), magnetoresistive random-access memory (MRAM), phase change RAM (PCRAM), Synchronous Dynamic Random Access Memory (SDRAM), Double Data Rate (DDR) RAM, memristor, flash memory, the like, or a combination thereof. In some examples, different memories (e.g., flash memories) in an electronic device may store separate data for same or different circuitries. For instance, instructions may be stored in Serial Peripheral Interface (SPI) flash memory, instructions may be stored in eMMC memory, or a combination thereof, etc. In some examples, memory may refer to a non-transitory tangible machine-readable storage medium, where the term “non-transitory” does not encompass transitory propagating signals.

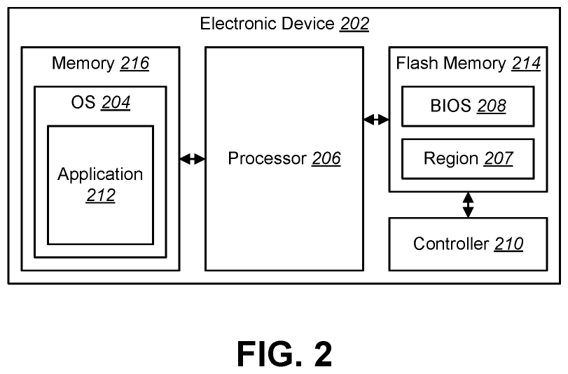

In some examples, the controller 101, the OS 103, and the BIOS 109 may be respective examples of the controller 210, OS 204, and the BIOS 208 described in FIG. 2. In some examples, portions of the electronic device 202 may be coupled via an interface (e.g., bus(es), wire(s), connector(s), etc.). As used herein, the term “couple” or “coupled” may denote a direct connection (without an intervening component) or an indirect connection (with an intervening component(s)). In some examples, the controller 101 may be coupled via a bus (e.g., SPI bus) to the OS 103, to the BIOS 109, or a combination thereof.

As used herein, a BIOS refers to hardware or hardware and instructions to initialize, control, or operate a device (e.g., computing device 338, electronic device 202, etc.) prior to execution of an OS of the device, during execution of the OS of the device, or a combination thereof. Instructions included within a BIOS may be software, firmware, microcode, or other programming that defines or controls functionality or operation of a BIOS. In one example, a BIOS may be implemented using instructions, such as platform firmware of a device, executable by a processor. In some examples, the controller 101 may execute BIOS instructions to perform an operation or operations described herein. In some examples, BIOS instructions may be stored in a memory (e.g., flash memory, ROM, etc.) and executed by the controller 101 to perform a BIOS operation. A BIOS may operate or execute prior to the execution of an OS of a device, during the execution of the OS, or a combination thereof. A BIOS may initialize, control, or operate components such as hardware components of a device and may load or boot an OS of a device.

In some examples, a BIOS may provide or establish an interface between hardware devices or platform firmware of the device and an OS of the device, via which the OS of the device may control or operate hardware devices or platform firmware of the device. In some examples, a BIOS may implement the Unified Extensible Firmware Interface (UEFI) specification or another specification or standard for initializing, controlling, or operating a device.

As used herein, an OS refers to hardware or hardware and instructions to control or operate a device (e.g., computing device 338, electronic device 202, etc.). For instance, an OS may operate after a boot procedure performed by a BIOS. Instructions included in an OS may be code, microcode, or other programming that defines or controls functionality or operation of an OS. In one example, an OS may be realized using instructions executable by a processor. In some examples, the controller 101 may execute OS instructions to perform an operation or operations described herein.

In some examples, OS instructions may be stored in an electronic, magnetic, optical, other physical storage device, or a combination thereof. In some examples, OS instructions may be stored in a first memory device with greater storage capacity than a second memory device to store BIOS instructions.

At step 111, the OS 103 reads a data package. For instance, an application in the OS 103 may read the data package. In some examples, the OS 103 may receive a data package from another device (e.g., a thumb drive, a web server, etc.). In some examples, the controller 101 may read the data package from a storage device, communication interface (e.g., wired interface, wireless interface, Ethernet interface, Institute of Electrical and Electronics Engineers (IEEE) 802.11 (Wi-Fi) interface, Bluetooth interface, etc. In some examples, the data package may be loaded into memory (e.g., RAM). The data package may include instructions (e.g., firmware), version information (e.g., firmware version number), a signature, or a combination thereof. For instance, the data package may include a set(s) of instructions (e.g., firmware) for a component(s) of an electronic device. For example, the data package may include first instructions (e.g., first firmware) for a component of the electronic device and second instructions (e.g., second firmware) for the BIOS 109. In some examples, the instructions may be signed instructions. For instance, the data package may include a signature or the OS 103 may add a signature. Signed instructions are instructions accompanied by a signature. For instance, signed instructions may be programmatic instructions, an application, firmware, driver, etc., signed by an entity.

At step 113, the OS 103 sends data to the BIOS 109. For instance, an application in the OS 103 may send the data to the BIOS 109. The data may include a signature(s), version information, instructions, or a combination thereof. In some examples, the data may include the data package.

At step 115, the BIOS 109 verifies a signature(s). For instance, the BIOS 109 may decrypt a signature of the signed instructions to produce a first integrity hash. The BIOS 109 may hash contents (e.g., hash the instructions of the signed instructions) to produce a second integrity hash. In a case that the first integrity hash and the second integrity hash match, the verification is successful. In a case that the first integrity hash and the second integrity hash do not match, the verification failed. If the integrity verification failed, the procedure may end. For instance, the signed instructions may be unverified (e.g., reported as untrusted or unverified). In some examples, the BIOS 109 may perform another verification procedure(s). For instance, the BIOS 109 may determine whether the instructions are allowed (e.g., whether the instructions are compatible with a component(s) electronic device), whether the version of the instructions indicates a newer version of the instructions, or a combination thereof.

In a case that the verification is successful, the BIOS 109 sends a message to the controller 101 at step 117. For instance, the BIOS 109 may send version information, instructions, or a combination thereof. In some examples, the BIOS 109 may send the version information to the controller 101 via a secured path (e.g., hash-based message authentication code (HMAC) signed shared memory window).

At step 119, the controller 101 unlocks a region. For instance, the controller 101 may unlock a region in flash memory in a case that the controller 101 is available (e.g., ready). Unlocking the region may allow for updating (e.g., writing to) the region.

At step 121, the controller 101 indicates the unlocking to the BIOS 109. For instance, the controller 101 may send a message to the BIOS 109 indicating that the region is unlocked.

At step 123, the BIOS 109 instructs the OS 103 to proceed with the update. For instance, the BIOS 109 may send a message to an application in the OS 103, where the message instructs the application to proceed with the update.

At step 125, the OS 103 performs the update. For instance, the OS 103 (e.g., an application, task, or combination thereof) writes the instructions to the region in flash memory.

At step 127, the OS 103 checks the update. For instance, once the update is complete (e.g., once the instructions are written to the region of flash memory), the OS 103 (e.g., application, task, or combination thereof in the OS 103). In some examples, the OS 103 may query the BIOS 109 or a task for an update status.

In a case that the update check passes, the OS 103 indicates the update status to the BIOS 109 at step 129. For instance, the OS 103 (e.g., application in the OS 103) may send an indicator of the update status to the BIOS 109.

At step 131, the BIOS 109 indicates the update status to the controller 101. For instance, the BIOS 109 may send an indication of the update status to the controller 101 via the secured path (e.g., HMAC signed shared memory window). The indication of the update status may indicate that the update is complete.

At step 133, the controller 101 locks the region. For instance, the controller 101 may lock the region in flash memory in response to the indicator of the update status. Locking the region may restrict (e.g., block) writing to the region, erasing in the region, or a combination thereof.

At step 135, the controller 101 calculates a hash of the region. For instance, the controller 101 may utilize the instructions stored in the region to calculate a hash.

At step 137, the OS 103 stores the instructions in storage. For instance, the OS 103 may store the instructions in a drive (e.g., hard disk drive, drive partition, globally unique identifier (GUID) partition table (GPT) table partition, etc.).

At step 139, the controller 101 resets. For instance, the controller 101 may shut down and reactivate.

At step 141, the controller 101 checks the instructions. For instance, the controller 101 may compare the hash of the region, the firmware version number, other information, etc., from the original instructions. If information (e.g., hashes, version numbers, other information, a combination thereof, all information, etc.) matches, the instructions in the region may pass the check.

At step 143, the controller 101 updates recovery instructions. For instance, the controller 101 may copy instructions into storage for recovery instructions (e.g., a golden copy) that may be utilized for recovery procedures if a failure occurs.

FIG. 2 is a block diagram illustrating an example of an electronic device 202 that may be used to perform an instruction update. Examples of the electronic device 202 may include a computer (e.g., desktop computer, laptop computer, server computer, etc.), a smartphone, a tablet computer, a game console, etc. The electronic device 202 may include a memory 216, processor 206, a flash memory 214, and a controller 210. In some examples, the processor 206 may include a central processing unit (CPU) (e.g., host CPU). The CPU may be a processor to perform an operation on the electronic device 202. Examples of the processor 206 may include a general-purpose processor, a microprocessor, etc. In some examples, the processor 206 may be an application processor. In some examples, the processor 206 may execute instructions (e.g., a program, verification program, etc.) stored in the memory 216.

In some examples, the electronic device 202 may include a memory 216 to store OS instructions. For instance, instructions for an OS 204 may be stored in an electronic, magnetic, optical, other physical storage device, or a combination thereof, that contains or stores electronic data (e.g., information and instructions). In some examples, the memory 216 may include multiple devices (e.g., a RAM card and a solid state drive (SSD)). In some examples, the OS 204 may include data, instructions for execution by the processor 206, or a combination thereof. In some examples, the memory 216 may be separate from a flash memory 214 to store BIOS instructions. In some examples, the memory 216 to store OS instructions may have a larger storage capacity than the flash memory 214 to store BIOS instructions. In some examples, the memory 216 may be coupled to a motherboard (not shown in FIG. 2) of the electronic device 202 (via serial advanced technology attachment (SATA), parallel advanced technology attachment (PATA), integrated drive electronics (IDE), non-volatile memory express (NVMe), RAM slot(s), or a combination thereof, for instance).

The processor 206 may be a logic circuit. For instance, the processor 206 may be a logic circuit capable of performing logical operations. Examples of the processor 206 may include a field-programmable gate array (FPGA), application-specific integrated circuit (ASIC), CPU, etc. For instance, the processor 206 may be a CPU or another processor. In some examples, the processor 206 may be coupled to a processor socket of a motherboard of the electronic device 202. In some examples, the processor 206 may be attached (e.g., soldered) to a motherboard of the electronic device 202.

In some examples, the electronic device 202 may include a flash memory 214 to store BIOS instructions. In some examples, the flash memory 214 may be non-volatile memory circuitry, EPROM, EEPROM, flash memory, or a combination thereof. For example, BIOS instructions may be stored in NAND flash memory or NOR flash memory. In some examples, the flash memory 214 may be attached (e.g., soldered) to a motherboard of the electronic device 202. In some examples, the BIOS 208 may include firmware (e.g., firmware executable by the processor 206 to boot the electronic device 202).

The processor 206 may be coupled to the memory 216 and to the flash memory 214. For instance, the processor 206 may be coupled to the memory 216 and the flash memory 214 with an interface, wire, bus, or a combination thereof. In some examples, the processor 206 may be coupled to the memory 216 and the flash memory 214 with a serial peripheral interface (e.g., SPI or eSPI) bus. For instance, the electronic device 202 may include a serial peripheral interface bus, where the processor 206 may access the memory 216 via the serial peripheral interface bus, may access the flash memory 214 via the serial peripheral interface bus, or may perform a combination thereof.

In some examples, the processor 206 may execute the OS 204. For instance, the processor 206 may execute the BIOS 208 in the flash memory 214 to boot the OS 204 and may execute the OS 204 in the memory 216 after booting. The memory 216 (e.g., OS 204) may include an application 212. For instance, the application 212 may be installed on the electronic device 202 (e.g., in the OS 204). The processor 206 may execute the application 212 to update instructions in the flash memory 214 (e.g., the BIOS 208, instructions in a region 207 of the flash memory 214, or a combination thereof).

In some examples, the electronic device 202 may receive a data package. For instance, the electronic device 202 may receive a data package from another device, from an external storage device (e.g., thumb drive, external hard drive, etc.), or a combination thereof. The data package may include instructions (e.g., BIOS 208 firmware, instructions for another component(s), or a combination thereof), version information (e.g., firmware version(s), instruction version(s), etc.), a signature(s), or a combination thereof. In some examples, the data package may be loaded into the memory 216. In some examples, the application 212 may add a signature(s) to the data package.

In some examples, the application 212 (e.g., the processor 206 executing the application 212) may send data to the BIOS 208. The data may include all or a portion of the data package. For instance, the data may include a version indicator(s), signature(s), instructions, or a combination thereof. In some examples, the BIOS 208 may perform a verification based on a signature included in the data. For instance, the BIOS 208 may determine whether the signature included in the data corresponds to a trusted entity. In some examples, the BIOS 208 may perform a verification based on a version indicator included in the data. For instance, the BIOS 208 may determine whether the version indicator indicates that corresponding instructions are compatible with a component(s) of the electronic device 202, whether the version indicator indicates that corresponding instructions are a newer version (e.g., more recently released or updated instructions).

If the verification succeeds, the BIOS 208 (e.g., the processor 206 executing the BIOS 208) may send a message to the controller 210. In some examples, the message includes the version indicator(s), the instructions (e.g., firmware), or a combination thereof. The controller 210 may be a logic circuit. Examples of the controller 210 an FPGA, ASIC, embedded controller, embedded security controller, etc. In some examples, the controller 210 may be coupled to a motherboard of the electronic device 202. For instance, the controller 210 may be attached (e.g., soldered) to a motherboard of the electronic device 202. The controller 210 may be separate from the processor 206. In some examples, the controller 210 may control access (e.g., read access, write access, or a combination thereof) to the flash memory 214. For instance, the controller 210 may control bus access to the flash memory 214 (or a portion(s) thereof) to enable (e.g., unlock) or disable (e.g., lock) writing to the flash memory 214.

In some examples, the controller 210 may unlock a region 207 of the flash memory 214 based on the message from the BIOS 208. For instance, if the controller is available (e.g., not busy performing another task), the controller 210 may unlock the region 207 for writing (e.g., enable overwriting data currently stored in the region 207). For instance, the controller 210 may set a bus to a state that allows writing to the region 207. In some examples, the region 207 may be a non-BIOS region in the flash memory 214. For instance, the region 207 may include data other than BIOS 208 instructions (e.g., other than BIOS 208 firmware). In some examples, the region 207 may include data (e.g., instructions, firmware, etc.) corresponding to another component(s) (e.g., engine(s), circuitry(ies), platform controller hub (PCH), converged security and management engine (CSME), etc.) of the electronic device 202. In some examples, the region 207 may include a subset of data (e.g., instructions, firmware, etc.) corresponding to a component(s). For instance, the region 207 may correspond to instructions (e.g., recovery instructions) to run a component(s). In some examples, the controller 210 may indicate the unlocking to the BIOS 208. In response to the unlocking indication, the BIOS 208 may instruct the application 212 to proceed with the update.

The application 212 in the OS 204 may update instructions in the region 207. For instance, in response to the instruction from the BIOS 208, the application 212 may proceed with updating instructions in the region 207. In some examples, the application 212 may update the instructions in the region 207 when the OS 204 is loaded and the electronic device 202 is in an awake state. For instance, when the OS 204 is booted and the electronic device 202 is in an awake state (e.g., S0 state of an advanced configuration and power interface (ACPI)), the application 212 may proceed to update instructions (e.g., firmware) in the region 207. In some examples, the application 212 may update the instructions in the region 207 by writing instructions (e.g., firmware) from the data package to the region 207. In some examples, the application 212 may perform another update(s) to flash memory 214. For instance, the application 212 may update BIOS 208 instructions.

In some examples, the application 212 may update the instructions as a background procedure. For instance, updating the instructions in the region 207 may be performed while the OS 204 is available to perform another task(s) (e.g., when a second application in the OS 204 is running).

In some examples, the application 212 may send an update completion indicator to the BIOS 208 when the update is complete. For instance, the update completion indicator may indicate that the application 212 has finished writing the instructions to the region 207.

In some examples, the BIOS 208 may send the update completion indicator to the controller 210 when the update is complete. The controller 210 may lock the region 207 after the update. For instance, the controller 210 may lock the region 207 in response to the update completion indicator. In some examples, the controller 210 may set a bus to a state that disables writing to the region 207.

In some examples, the controller 210 may determine a hash of the region 207. For instance, the controller 210 may calculate a hash of instructions in the region 207 using a hashing technique. In some examples, the hash may be utilized to verify the update.

In some examples, the electronic device 202 may reset after the update. For instance, the electronic device 202 (e.g., memory 216, processor 206, flash memory 214, controller 210, or a combination thereof) may power cycle. In some examples, resetting the electronic device 202 may unload the OS 204, may set the electronic device 202 in a pre-boot state, or a combination thereof.

In some examples, the electronic device 202 may perform one, some, or all of the aspects, operations, elements, etc., described in one, some, or all of FIG. 1-7. In some examples, the electronic device 202 may include an element described in one, some, or all of FIG. 1-7.

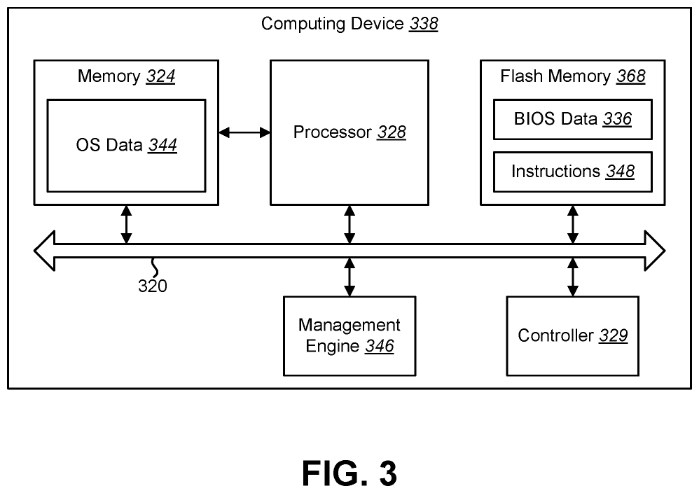

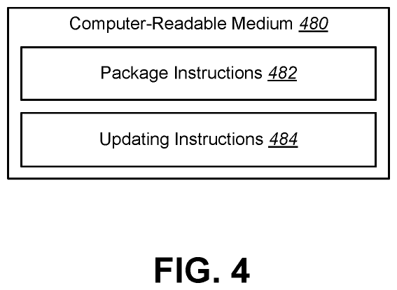

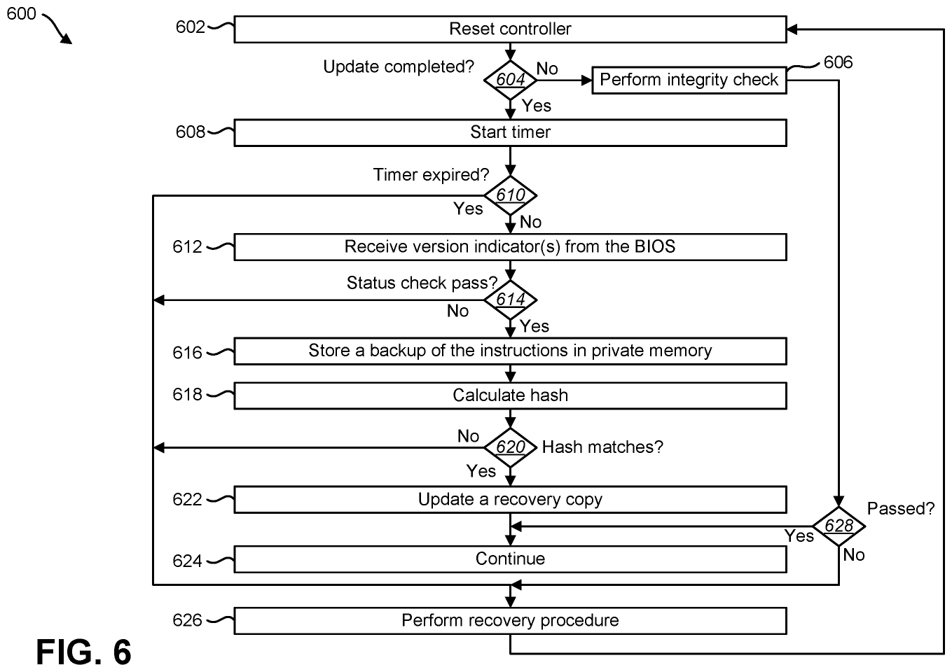

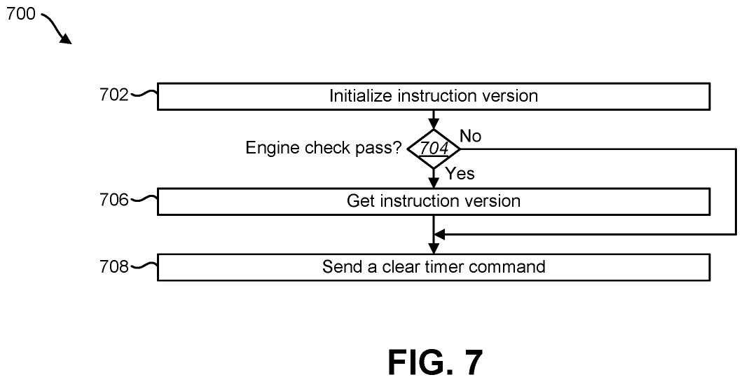

FIG. 3 is a block diagram illustrating an example of a computing device 338 to perform an instruction update. In some examples, the computing device 338 may perform the operations described in FIG. 1, FIG. 2, FIG. 4, FIG. FIG. 6, FIG. 7 or a combination thereof. The computing device 338 may be an example of the electronic device 202 described in FIG. 2. In some examples, the computing device 338 may include processor 328, a memory 324, a flash memory 368, a management engine 346, a controller 329, and a bus 320.

In some examples, one, some, or all of the components of the computing device 338 may be structured in hardware (e.g., circuitry). In some examples, the components described in FIG. 3 may be examples of corresponding components described in FIG. 1, FIG. 2, or a combination thereof. In some examples, the computing device 338 may perform one, some, or all of the operations described in FIG. 1-7.

In some examples, the processor 328, memory 324, flash memory 368, management engine 346, and controller 329 may be coupled to the bus 320. Examples of the bus 320 may include an SPI bus, eSPI bus, inter-integrated circuit (I2C) bus, general purpose input/output (GPIO) bus, or a combination thereof, etc. The bus 320 may be utilized to communicate a signal, information, or a combination thereof. In some examples, the electronic device 202 may include a coupling(s) in addition to the bus 320. For instance, the processor 328 may be coupled to the memory 324 independently of the bus 320.

Examples of the memory 324 may include RAM, a hard disk drive (HDD), NVMe memory, or a combination thereof, etc. The memory 324 may store OS data 344. OS data 344 may include information, instructions, or a combination thereof to provide an OS for the computing device 338. For instance, the computing device 338 may include an OS. In some examples of FIG. 3, an “OS” may refer to the processor 328 executing instructions in the OS data 344 to perform an operation(s).

In some examples, the OS data 344 may include an application(s). For instance, the OS data 344 may include an application(s) that are executable to update instructions 348 in the flash memory 368. In some examples, the OS may update the instructions 348 in a region of the flash memory 368 when the OS is booted and the computing device 338 is in an awake state. For instance, the computing device 338 may update the instructions 348 in the region of the flash memory 368 as described in relation to FIG. 1, FIG. 2, or a combination thereof.

Examples of the flash memory 368 may include ROM, EPROM, EEPROM, or a combination thereof, etc. The flash memory 368 may store BIOS data 336. BIOS data 336 may include information, instructions, or a combination thereof to provide a BIOS for the computing device 338. For instance, the computing device 338 may include a BIOS. In some examples of FIG. 3, a “BIOS” may refer to the processor 328 executing instructions in the BIOS data 336 to perform an operation(s).

In some examples, the computing device 338 may reset after updating the instructions 348 in the flash memory 368. For instance, the computing device 338 may be set to a pre-boot state.

In some examples, the controller 329 may set a timer when the OS is not booted. For instance, when the computing device 338 is in a pre-boot state (e.g., when the OS is not booted) after the instructions 348 have been updated, the controller 329 may set a timer. The timer may be set to a quantity of time (e.g., 10 seconds, 30 seconds, 1 minute, 2 minutes, etc.). The timer may expire if the timer reaches the quantity of time.

In some examples, the controller 329 may receive a version indicator from the BIOS. For instance, the BIOS may send a version indicator of instructions from the data package to the controller 329.

In some examples, the controller 329 may determine whether the instructions 348 pass a status check based on the version indicator. For instance, the controller 329 may determine whether a version of the instructions 348 stored in the flash memory 368 matches the version indicator. In a case that the version of the instructions 348 matches the version indicator, the controller 329 may produce a determination that the instructions 348 pass the status check based on the version indicator.

In some examples, the controller 329 may store a backup of the instructions in private memory. For instance, the controller 329 may have access to private memory (e.g., memory that is exclusively accessible to the controller 329). For instance, the controller 329 may copy the instructions 348 from the region to private memory.

In some examples, the controller 329 may calculate a first hash based on the backup. For instance, the controller 329 may utilize a hashing technique (e.g., SHA-1, SHA-2, SHA-256, SHA-384, etc.). In some examples, the controller 329 may compare the first hash with a second hash stored before the reset. For instance, the controller 329 may compare the first hash (from the backup in private memory, for example) with the second hash that is based on the instructions in the region of the flash memory 368 (e.g., from the region before the reset). In some examples, the controller 329 may update a recovery copy of the instructions from the private memory in a case that the first hash matches the second hash. For instance, the controller 329 may overwrite a recovery copy with the instructions from the private memory if the first hash and the second hash match.

In some examples, the instructions 348 in the region of the flash memory 368 may be instructions for the management engine 346. An example of the management engine 346 may include a converged security and management engine (CSME). In some examples, the management engine 346 may perform a security function(s) for a component(s) of the computing device 338. For instance, the management engine 346 may manage security for connection circuitry (e.g., peripheral component interconnect express (PCIe)) of the computing device 338 (e.g., motherboard). In some examples, the instructions 348 may be executed by the management engine 346. Some examples of the techniques described herein may enable updating the instructions 348 to be executed by the management engine 346 with enhanced security. For instance, an updating procedure for the instructions 348 may be controlled (e.g., gated) to occur when a new version of the instructions is available from a trusted source. For instance, other attempts to access or overwrite the instructions 348 may be blocked except for a period when the region is unlocked by the controller 329, which may allow an update to occur when the OS is loaded and when an authorized update is available.

In some examples, when an update is completed and checked, the processor 328 may produce a report indicating update success. In a case that an update is unsuccessful, the processor 328 may produce a report indicating update failure. The computing device 338 may output the report. For instance, the computing device 338 may display the results on a display device or display panel (e.g., monitor, touchscreen, television, etc.). In some examples, the computing device 338 may send the report to another device. For instance, the computing device 338 may include a communication interface (not shown in FIG. 3) that may be utilized to send the report to a remote computing device (e.g., server, desktop computer, tablet, smartphone, etc.).

FIG. 4 is a block diagram illustrating an example of a computer-readable medium 480 for an instruction update. The computer-readable medium 480 is a non-transitory, tangible computer-readable medium. In some examples, the computer-readable medium 480 may be, for example, RAM, DRAM, EEPROM, MRAM, PCRAM, a storage device, an optical disc, the like, or a combination thereof. In some examples, the computer-readable medium 480 may be volatile memory, non-volatile memory, or a combination thereof. In some examples, the computer-readable medium 480 described in FIG. 4 may be an example of memory including instructions to be executed by a processor to update instructions. For instance, the computer-readable medium 480 may be an example of the memory 324 described in FIG. 3. In some examples, the computer-readable medium 480 may be separate from a flash memory 368.

The computer-readable medium 480 may include data (e.g., information, instructions). In the example of FIG. 4, the computer-readable medium 480 includes package instructions 482 and updating instructions 484.

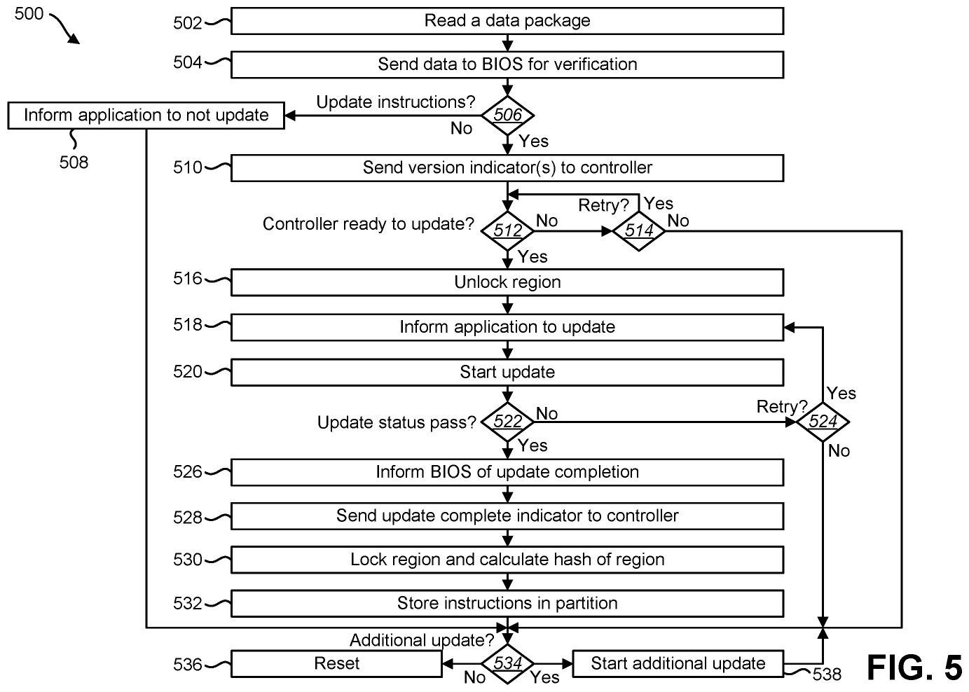

The package instructions 482 may include instructions that, when executed, cause a processor of an electronic device to send a data package to a BIOS to verify the data package. For instance, the data package may include a signature(s), version information, or a combination thereof. In some examples, sending the data package may be performed as described in FIG. 1, FIG. 2, FIG. 3, FIG. 5, or a combination thereof.

The updating instructions 484 may include instructions that, when executed, cause the processor to update instructions in a region of a flash memory based on an update indication from the BIOS when an OS is loaded, and the electronic device is in an awake state. For instance, the update indication may be received from the BIOS when the region is unlocked by a controller. In some examples, the processor may execute the updating instructions 484 to call a task (e.g., update routine, third-party updating tool, etc.) to update the instructions (while the region is unlocked, for instance). In some examples, the region of flash memory is locked after the update. In some examples, updating the instructions may be performed as described in FIG. 1, FIG. 2, FIG. 3, FIG. 5, or a combination thereof.

In some examples, the updating instructions 484, when executed, cause the processor to check an update status. For instance, the processor may query the update status through an update tool, through the BIOS, or a combination thereof. In some examples, the updating instructions 484, when executed, cause the processor to send an update completion indicator to the BIOS when the update is complete. For instance, if the update status indicates that the update status is positive, the processor may send an update completion indicator to the BIOS. In some examples, the updating instructions 484, when executed, cause the processor to store the instructions in a hard disk drive partition after the update (e.g., after the instructions have been written to the region in the flash memory).

FIG. 5 is a flow diagram illustrating an example of a method 500 for updating instructions. The method 500 or a method 500 element may be performed by an electronic device, computing device, or apparatus (e.g., electronic device 202, computing device 338, laptop computer, smartphone, tablet device, smartphone, etc.). For example, the method 500 may be performed by the electronic device 202 described in FIG. 2 or the computing device 338 described in FIG. 3.

At step 502, an electronic device may read a data package. For instance, the electronic device may receive a data package from a remote device (e.g., web server, networked device, etc.), from a coupled device, or a combination thereof. In some examples, an application (e.g., application 212) may read a signed portion and a signature from a data package that includes a BIOS version and an instruction version.

At step 504, the electronic device may send data to the BIOS for verification. For instance, before an instruction update begins, the application (e.g., firmware update OS tool) may send data that indicates the new BIOS version, instruction version, and a signature.

At step 506, the electronic device may determine whether to update the instructions. In some examples, the BIOS may verify that the signature is authentic, that the instructions are allowed (e.g., whitelisted), and that the instruction version is different from the current version. In a case that the verification fails (e.g., signature verification fails, instructions are not allowed, or instruction version is the same), the electronic device may inform the application to not update at step 508 and operation may proceed to step 534.

In a case that the verification is successful (e.g., if all the checks pass), the electronic device may send a version indicator(s) to a controller at step 510. For instance, the BIOS may send an instruction version indicator and a BIOS version indicator to the controller through a secured path (e.g., HMAC signed shared memory window).

At step 512, the electronic device may determine whether the controller is ready to update. For instance, the controller may be busy with another task. In a case that the controller is not ready to update, the electronic device may determine whether to retry the update at step 514. For instance, the electronic device may maintain a counter that tracks a quantity of update attempts. The counter may increment each time the update is attempted and the controller is not ready. For instance, if the counter reaches a threshold value (e.g., 10), the electronic device may determine to not retry and operation may proceed to step 534. If the counter has not reached the threshold value, the electronic device may attempt to update again.

In a case that the controller is ready to update (e.g., available to update, not busy with another task, etc.), the electronic device may unlock a region of flash memory at step 516. For instance, the controller may unlock the region of the instructions in the flash memory, which may allow the OS (e.g., application) to update the region in the flash memory.

At step 518, the electronic device may inform an application to update. For instance, once the region is unlocked, the BIOS may inform the OS (e.g., application) to start the instruction update.

At step 520, the electronic device may start the update. For instance, the application may call a task (e.g., instruction update tool) to update the instructions. In some examples, the update may run in the background.

At step 522, the electronic device may determine whether an update status passes. For instance, once the instruction update completes, the OS (e.g., application, task, instruction update tool, etc.) verifies that the new instructions have a positive status.

In a case that the update status fails, the electronic device may determine whether to retry the update at step 524. For instance, the electronic device may maintain a counter that tracks a quantity of update attempts (which may be the same counter as described relative to step 514 or a separate counter). The counter may increment each time the update is attempted and the update status fails. For instance, if the counter reaches a threshold value (e.g., 10), the electronic device may determine to not retry and operation may proceed to step 534. If the counter has not reached the threshold value, the electronic device may attempt to update again. In a case that the electronic device determines to attempt the update again, the operation may return to step 518.

In a case that the update status passes, the electronic device may inform the BIOS about the completion of the instruction update at step 526. At step 528, the electronic device may send an update complete indicator (e.g., command) to the controller. For instance, the BIOS may send the update complete indicator to the controller through the secured path (e.g., HMAC shared memory).

At step 530, the electronic device may lock the region, calculate a hash of the region, or a combination thereof. For instance, the controller may lock the region to block writing or erasing the region. The controller may calculate and store the hash of the region (e.g., region in shared SPI).

At step 532, the electronic device may store instructions in a partition. For instance, the OS (e.g., application) may store the new instructions (e.g., firmware bin) in a hard disk drive GPT partition.

At step 534, the electronic device may determine whether there is an additional update. For instance, the electronic device may determine whether the data package includes another update (e.g., BIOS firmware update, other flash memory update, etc.). In a case that there is no remaining update (e.g., all update(s) have been addressed), the electronic device may reset at step 536. In a case that there is an additional update, the electronic device may start the additional update at step 538. For instance, the additional update may follow similar or different procedures from those of the method 500. An additional update(s) may be applied until no update remains.

FIG. 6 is a flow diagram illustrating an example of a method 600 for checking instructions. The method 600 or a method 600 element may be performed by an electronic device, computing device, or apparatus (e.g., electronic device 202, computing device 338, laptop computer, smartphone, tablet device, smartphone, etc.). For example, the method 600 may be performed by the electronic device 202 described in FIG. 2 or the computing device 338 described in FIG. 3.

At step 602, an electronic device may reset a controller. For instance, the electronic device may deactivate and reactivate the controller. In some examples, resetting the controller may be performed as part of restarting the electronic device (e.g., shutting down the OS and powering on the electronic device).

At step 604, the electronic device may determine whether an update was completed. Before the next boot, for instance, the controller may read a record indicating whether an instruction update occurred. In a case that no update was completed, the electronic device may perform an integrity check at step 606. For instance, the electronic device may perform an integrity check procedure of the BIOS, flash memory, component(s), or a combination thereof and operation may proceed to step 628. At step 628, the electronic device may determine whether the integrity check passed. In a case that the integrity check fails, the electronic device may perform a recovery procedure at step 626. For instance, the electronic device may utilize recovery instructions to roll back the update (e.g., restore to a previous instruction version, firmware version, BIOS version, or a combination thereof). In some examples, performing the recovery procedure may include performing a reset and replacing, by the controller, the instructions in flash memory (e.g., shared flash) with a recovery copy (e.g., golden copy) from private memory (e.g., private flash) in a pre-boot state. The controller may set another component (e.g., engine(s), CSME, etc.) in a recovery mode and wake up the electronic device. Operation may return to step 602. When the electronic device wakes, the BIOS may perform an instruction update to take the component (e.g., engine(s), CSME, etc.) out of recovery mode.

In a case that the integrity check passes, the electronic device may continue 624 a startup procedure. For instance, the electronic device may proceed to boot the electronic device.

In a case that the update was completed, the electronic device may start a timer at step 608. For instance, the controller may skip the integrity check for the region and may set a timer (e.g., approximately a minute until expiration). The electronic device may determine whether the timer is expired at step 610. In a case the timer expires (without receiving a version indicator from the BIOS, for instance), the electronic device may perform a recover procedure at step 626.

In some examples, before the timer expires, the controller may receive a version indicator(s) from the BIOS at step 612. For instance, the BIOS may query a status (e.g., instruction status, engine status, or a combination thereof) and an instruction version. The BIOS may send the instruction information (e.g., version indicator(s)) to the controller.

At step 614, the electronic device may determine whether a status check passes. For instance, if the version indicator indicates that the version is not a current version or the status is negative, the status check may fail and operation may proceed to a recovery procedure at step 626. If the version indicator indicates that the version is the current version and if the status is positive, the status check may pass. For instance, If the instruction version and the BIOS version match the respective versions that the BIOS indicated to the controller before the update began, the status check may pass.

If the status check passes, the electronic device (e.g., controller) may store a backup of the instruction in private memory at step 616. For instance, the controller may copy the new instructions in the region of the flash memory (e.g., shared SPI) in private memory (e.g., a flash memory that is isolated to the controller).

The electronic device (e.g., controller) may calculate a hash at step 618. For instance, the controller may calculate a hash of the instructions in the private memory.

At step 620, the electronic device may determine whether the hash matches another hash (e.g., previously calculated hash). If the hash does not match, operation may proceed to step 626. For instance, if the hash comparison fails or if the timer expires, the controller may start the recovery procedure.

If the hash matches (e.g., if the hash of the instructions in the private memory matches with a previously calculated hash value), the electronic device may update a recovery copy at step 622. For instance, the controller may replace the instruction recovery copy (e.g., backup golden copy) with the instructions stored in the private memory. Once the instruction recovery copy is updated, the controller may be prepared to perform another (e.g., subsequent) instruction update.

In some examples of the techniques described herein, an instruction update application programming interface (API) may remain open in the OS and may allow a task or tool to update the instructions. After the electronic device reboots, the controller may capture the instruction in the region in parallel with the BIOS boot (without providing a blocking action, for instance).

FIG. 7 is a flow diagram illustrating an example of a method 700 for managing update checking. The method 700 or a method 700 element may be performed by an electronic device, computing device, or apparatus (e.g., electronic device 202, computing device 338, laptop computer, smartphone, tablet device, smartphone, etc.). For example, the method 700 may be performed by the electronic device 202 described in FIG. 2 or the computing device 338 described in FIG. 3. In some examples, the method 700 may be performed during a post procedure (e.g., boot procedure) for a BIOS.

At step 702, an electronic device may initialize an instruction version. For instance, the BIOS may set a variable indicating an instruction version to zero.

At step 704, the electronic device may determine whether an engine check passes. For instance, the BIOS may determine whether an engine (e.g., CSME) is in a positive state or is in recovery mode.

In a case that the engine check passes (e.g., if the engine is in a positive state), the electronic device may get an instruction version at step 706. For instance, the BIOS may set the instruction version to the version of the instructions in the region. In a case that the engine check fails (e.g., if the engine is in a recovery mode), the electronic device (e.g., BIOS) may skip step 706.

At step 708, the electronic device may send a clear timer command. For instance, the BIOS may send a clear timer command to the controller with a version indicator indicating the instruction version. After the method 700, the BIOS post procedure may continue.

Some examples of the techniques described herein may allow moving updating and backup procedures into the background during OS operation and a boot phase. For instance, some examples of the techniques may allow an end user to remain productive and retain access to a computer while the update is performed, while reducing risk to the integrity of the region or increasing the resilience of the region (e.g., backup stored in private flash). Some examples of the techniques described herein may provide increased insight and control over update procedures. Some examples of the techniques described herein may utilize hardware capabilities in a controller with some handshaking between an OS, BIOS, and the controller (and an engine in some examples) to allow instructions (e.g., engine instructions) to be updated from the OS without compromising the security and resilience of the instructions.

As used herein, items described with the term “or a combination thereof” may mean an item or items. For example, the phrase “A, B, C, or a combination thereof” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, operation(s), function(s), aspect(s), or element(s) of the examples described herein may be omitted or combined.

What is claimed is:

1. An electronic device, comprising:
a flash memory;
a basic input/output system (BIOS);
a controller to unlock a region of the flash memory based on a message from the BIOS; and
an operating system (OS), wherein an application in the OS is to update instructions in the region when the OS is loaded and the electronic device is in an awake state, and wherein the controller is to lock the region after the update.

2. The electronic device of claim 1, wherein the region is a non-BIOS region in the flash memory.

3. The electronic device of claim 1, wherein the application is to add a signature to a data package.

4. The electronic device of claim 1, wherein the application is to send data to the BIOS, and wherein the BIOS is to perform a verification based on a signature included in the data.

5. The electronic device of claim 4, wherein the BIOS is to perform the verification further based on a version indicator included in the data.

6. The electronic device of claim 5, wherein the message includes the version indicator.

7. The electronic device of claim 1, wherein the application is to update the instructions as a background procedure when a second application in the OS is running.

8. The electronic device of claim 1, wherein the application is to send an update completion indicator to the BIOS when the update is complete.

9. The electronic device of claim 8, wherein the BIOS is to send the update completion indicator to the controller when the update is complete, and wherein the controller is to lock the region in response to the update completion indicator.

10. The electronic device of claim 9, wherein the controller is to determine a hash of the region.

11. A computing device, comprising:
a flash memory;
a basic input/output system (BIOS);
an operating system (OS) to update instructions in a region of the flash memory when the OS is booted and the computing device is in an awake state;
a controller to:
set a timer when the OS is not booted;
before the timer expires, receive a version indicator from the BIOS; and
produce a determination that the instructions pass a status check based on the version indicator.

12. The computing device of claim 11, wherein the controller is to store a backup of the instructions in private memory.

13. The computing device of claim 12, wherein the controller is to calculate a first hash based on the backup.

14. The computing device of claim 13, wherein the controller is to compare the first hash with a second hash stored before a reset.

15. The computing device of claim 14, wherein the controller is to compare the first hash with the second hash that is based on the instructions in the region of the flash memory.

16. The computing device of claim 15, wherein the controller is to update a recovery copy of the instructions from the private memory in a case that the first hash matches the second hash.

17. A non-transitory tangible computer-readable medium comprising instructions when executed cause a processor of an electronic device to:
send a data package to a basic input/output system (BIOS) to verify the data package; and
update second instructions in a region of a flash memory based on an update indication from the BIOS when an operating system (OS) is loaded and the electronic device is in an awake state, wherein the region of the flash memory is locked after the update.

18. The non-transitory tangible computer-readable medium of claim 17, wherein the instructions when executed cause the processor to check an update status.

19. The non-transitory tangible computer-readable medium of claim 18, wherein the instructions when executed cause the processor to send an update completion indicator to the BIOS when the update is complete.

20. The non-transitory tangible computer-readable medium of claim 17, wherein the instructions when executed cause the processor to store the second instructions in a hard disk drive partition after the update.
